(19) United States
(12) Patent Application Publication
(10) Pub. No.: US 2004/0190587 A1
(43) Pub. Date: Sep. 30, 2004

(54) Device and method for determining the boiling point of a liquid

(76) Inventors: Heinz Eisenschmid, Ditzingen-Hirschlanden (DE); Michael Stumber, Korntal-Muenchingen (DE)

Correspondence Address: KENYON & KENYON, ONE BROADWAY, NEW YORK, NY, 10004, US

(21) Appl. No.: 10/723,419

(22) Filed: Nov. 26, 2003

(30) Foreign Application Priority Data
Nov. 27, 2002 (DE) 10255325.4-52

(51) Int. Cl. G01N 25/02

(52) U.S. Cl. 374/16

(57) ABSTRACT

A device for determining the boiling point of a hydraulic fluid of a hydraulic system, including an electrical heating element which is situated in the fluid. The electrical heating element acts, in this context, as an actuator of a micropump and is situated in a chamber of same. In addition, a method for determining the boiling point of a fluid of a hydraulic system, using a device having a heating element, in which the fluid is conveyed into a chamber of a micropump with the aid of a heating element, and there it is heated to boiling with the aid of the heating element, after which the boiling point of the fluid is ascertained in the light of the electrical resistance of the heating element.

### BACKGROUND INFORMATION

Hydraulic fluids, particularly brake fluids in motor vehicle braking systems, are hygroscopic, as a rule, and consequently attract water from the environment. This lowers their boiling point, which requires a regular replacement of the fluid. However, what may also happen is an unexpected, premature aging of the fluid, which may be caused by the operating mode in each case, and may lead to failure of the respective hydraulic or braking system. For this reason, it is desirable to be able constantly to monitor the boiling point of hydraulic fluids such as brake fluid.

A device of the kind is described in German Patent Application No. 36 39 664, and is used particularly for determining and monitoring the state of a hydraulic fluid that is located in a braking system of a motor vehicle. For this, the known device has a heating element used as a sensor element, with the aid of which a so-called characteristic value of the fluid is able to be determined, namely in such a way that the brake fluid surrounding the heating element is heated up to a temperature lying below the boiling point, so that a stable cellular convection is created which is able to be evaluated as a measure of the state of the fluid. The instantaneous temperature of the fluid can be ascertained by measuring the temperature-dependent resistance of the heating element. From a comparison of the instantaneous temperature of the brake fluid with a borderline boiling temperature of the brake fluid that is still permissible, the so-called thermal reserve of the brake fluid can be ascertained, which can be used as a measure of the further usability of the brake fluid. However, using this known device, the actual boiling point of the brake fluid cannot be determined.

German Patent Application No. 40 02 792 describes a device for ascertaining the state of a pressure transfer fluid. This device includes two electrodes which are connected to each other via a sensor element designed as a linear conductor. A boiling point determination is performed by heating the sensor element situated in the brake fluid, a stable cellular convection thereby setting in in the vicinity of the sensor element. Such a cellular convection sets in when the sensor element or heating element used as convection element generates a quantity of heat in the directly adjacent fluid space which can no longer be conducted on rapidly enough to this surrounding total volume by laminar convection. Hereby boundary layers form which surround the heating element at a slight distance like a sheath fluid. Inside such a cell there is created a heat backup (buildup) right up to the heating element. The cell can give off just as much heat, by laminar convection, toward the outside into the fluid space as can be absorbed and distributed in this space, per unit of time.

The heating element and its convection cell surroundings thus behave as a common heating entity which, with respect to laminar convection relationships to the residual fluid is in a state of thermal capacity adaptation. The boundary layer remains stable, as long as the backup temperature on the inner side of the boundary layer is greater by a certain amount than at the outer side in the residual fluid.

For the determination of the boiling point with the aid of the device according to German Patent Application No. 40 02 792, the changeable heat resistance of the sensor element is evaluated as a result of the backup temperature at the boundary layer between the heater surface and the cell fluid. Now, in the case of hygroscopic brake fluids, the mixing with water effects a specific change in density and viscosity, and therewith in backup temperature. This change is utilized to determine the boiling point. A direct measurement of the boiling point of the brake fluid, however, is also not possible using this device.

From German Patent Application No. 197 10 358, in addition, a microstructured sensor is known which is used for determining the state of a fluid, such as a brake fluid in a motor vehicle brake system, via conductivity measurements and capacitance measurements with the aid of interdigital electrodes.

Furthermore, from the publication “T. Gerlach and H. Wurmus, Working Principle and Performance of the Dynamic Micropump, Sensor and Actuators, Vol. A50, pages 135-140, 1995” a micropump is known which is made up of a substrate made of a silicon monocrystal in which an inlet and an outlet are etched which lead to a pump chamber which is bordered by a cover element. A piezoelectric actuator is mounted on the cover element which is able to set the cover element into vibrations, so that a fluid may be taken in via the inlet and the fluid may be expelled via the outlet.

### SUMMARY OF THE INVENTION

The device according to the present invention for determining the boiling point of a hydraulic fluid in a hydraulic system, particularly for determining the boiling point of a brake fluid in a braking system of a motor vehicle, in which device the electrical heating element acts as an actuator of a micropump and is situated in a chamber thereof, has the advantage that the boiling point of the respective fluid is directly measurable. This occurs because the fluid contained in the chamber is heated by the heating element to the onset of boiling of the fluid. Upon the onset of boiling, heat removal from the heating element becomes abruptly worse, whereby the temperature at the heating element rises abruptly. Then, from the temperature resistance characteristics curve of the heating element one may conclude what the boiling point is.

In this way, knowing the boiling point of the nonaqueous hydraulic fluid, one may in turn judge the aging of the hygroscopic hydraulic fluid, since its boiling point decreases with an increase in its water content.

Furthermore, by the mode of operation of the heating element as pump actuator, a steady exchange of fluid in the pump chamber is guaranteed. The heating element acts as actuator of the micropump in such a way that when the fluid is heated in the chamber, gas bubbles appear, and thus fluid is displaced from the chamber. During cooling, the vapor bubbles in the chamber collapse so that fluid flows into, or is sucked into the chamber.

The device according to the present invention is basically usable with any hydraulic fluids.

Expediently, the device according to the present invention is laid out in such a way that the hydraulic circuit, to which the device is connected according to the present invention, is not impaired by the evaporation of the fluid in the chamber. This may be achieved especially in that the device is provided with an inlet and an outlet whose cross sections prevent the escape of gas bubbles from the chamber into the hydraulic circuit. Furthermore, the operating mode of the heating element is to be selected for this in such a way that its heating efficiency is reduced after the onset of the boiling of the fluid.

The device according to the present invention is preferably constructed in such a way that the heating element is mounted by thin film technology onto a substrate made of a semiconductor, such as silicon, glass, a ceramic or a plastic. In the latter case, the heating element may be structured directly on the plastic as an extrusion coated part made of metal or according to a so-called MID (molded interconnect device)-technique. To form the chamber, the substrate is furnished, in the vicinity of the heating element, with a cover which may also be formed of a semiconductor, such as silicon, of heat-resistant glass, of a ceramic or of plastic.

The inlet and the outlet of the chamber and the cavity are, for example, etched into the cover or into the substrate, which can be done using an appropriate etching mask. The shape of the inlet and outlet openings of the chamber is preferably selected so that the fluid is essentially displaced from the chamber via the outlet and taken in via the inlet. The outlet opening and the inlet opening may in each case have the shape of a tetragonal pyramid, the outlet opening widening out in the direction facing away from the chamber, and the inlet opening tapering in the direction facing away from the chamber. This is an especially space-saving solution in the case of openings etched into the substrate, the substrate being made of a semiconductor or of glass.

It is particularly advantageous to position the inlet opening and the outlet opening of the chamber in the cover or even in an intermediate layer formed as a separate layer of the cover, so that the inflow direction and the outflow direction of the hydraulic fluid run parallel to the plane of the substrate and the cover. The openings are then preferably formed like nozzles and preferably are trapeze-shaped, the chamber and the cavity also being formed in the cover and the intermediate layer. The sidewalls of the nozzles or openings preferably are at an angle with respect to the flow direction of the hydraulic fluid of approximately four to five degrees. But basically, in the case of openings put into the cover, their geometry may be freely selected over a wide range.

In one alternative specific embodiment, the construction is produced of ceramic layers, i.e. of so-called green tapes. One of the layers then forms the substrate, which forms a base plate on which the heating element is situated. On the base plate there is an additional ceramic layer which is assigned to the cover, and into which the chamber and the inlet and outlet openings have been stamped. This position is in turn bordered by a closing cover which also borders the chamber and the openings.

In one specific embodiment of the device according to the present invention, made of plastic, there is the advantage that no further housing protecting the device is required.

As materials for producing the heating elements, aluminum or platinum, for example, may be used. For insulating reasons, the heating element is expediently provided with a coating of a dielectric, such as silicon nitride or silicon dioxide.

In one especially advantageous specific embodiment of the device according to the present invention, an additional PTC resistance element is situated in the chamber or cavern, so that the temperature prevailing during an abrupt change in the resistance of the heating element can be directly read out.

Alternatively, the ascertainment of the temperature may also be carried out by a resistance measurement at the heating element, using a four-point tap.

The device according to the present invention, when used in a braking system of a motor vehicle, is situated preferably directly at the critical location(s) of the braking system, namely, advantageously in the immediate vicinity of the brake cylinder. Thus, during the operation of the motor vehicle, the temperature of the fluid may be constantly ascertained and monitored, and an optical and/or acoustical, or the like, warning signal may be triggered when a critical boiling temperature is measured.

The present invention also provides a method for determining the boiling point of a fluid of a hydraulic system having a device that has a heating element. In this method, the fluid is conveyed into a chamber of a micropump, using the heating element, and there it is heated by the heating element to boiling. Then the boiling point of the fluid is ascertained in the light of the resistance of the heating element.

By using the method according to the present invention, the boiling point of the fluid is directly determinable.

The heating element may be driven using direct or alternating current.

In the method and the device according to the present invention, one takes advantage of the effect that, when the fluid has been heated up to the onset of boiling, and above the heating element vapor bubbles appear, the heat removal from the heating element is abruptly worse, and with that, the temperature at the heating element rises abruptly. Knowing current and voltage at the heating element at the point in time of evaporation, one can then ascertain the instantaneous electrical resistance of the heating element, and from its temperature/resistance characteristics curve ascertain the boiling point of the fluid. Because of the appearance of the little vapor bubbles, fluid is displaced from the chamber of the micropump. During cooling due to the reduction of the heating performance, the little vapor bubbles collapse, whereby fluid again flows into the chamber. Consequently, a continuous fluid replacement takes place in the chamber, so that it is ensured that the fluid volume contained in the chamber is representative of the fluid of the hydraulic circuit.

### BRIEF DESCRIPTION OF THE DRAWINGS

FIG. 1 shows a section through a construction in principle of a device according to the present invention.

FIG. 2 shows the device according to FIG. 1 during the heating of a heating element.

FIG. 3 shows the device according to FIG. 1 during the cooling of a heating element.

FIG. 4 shows a section through an advantageous specific embodiment of the device according to the present invention.

FIG. 5 shows an exploded representation in perspective of the device according to FIG. 4.

FIG. 6 shows an exploded representation in perspective of an alternative specific embodiment of the device according to the present invention.

FIG. 7 shows an exploded representation in perspective of a further specific embodiment of the device according to the present invention.

### DETAILED DESCRIPTION

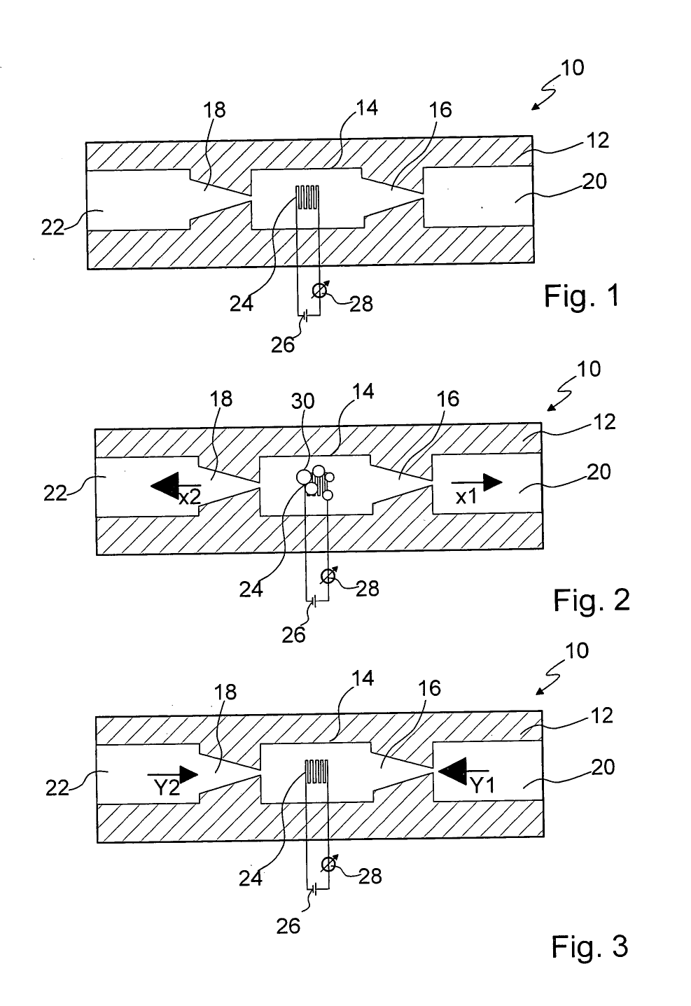

In FIGS. 1 to 3, the construction in principle of a device 10, for determining the boiling point of a hydraulic fluid is shown, as well as the function of device 10. Device 10 is used in a braking system of a motor vehicle that is not shown in more detail here.

Device 10 includes a housing 12 which is made of a silicon monocrystal or a silicon wafer. In housing 12, a chamber or cavity 14 is formed which is connected to lines 20 and 22, on the one hand via an inlet 16 and on the other hand via an outlet 18. Lines 20 and 22 are in turn connected to the hydraulic circuit of the braking system.

Inlet 16 and outlet 18 are each designed to be nozzle-shaped and developed essentially in pyramidal form, inlet 16 tapering in the direction facing away from cavity 14, i.e. in the direction of line 20, and outlet 18 widening in the direction facing away from cavity 14, i.e. in the direction of line 22.

In cavity 14 there is an electrical heating element 24, made of platinum, which is coated with a dielectric made of silicon nitride. The heating element is connected to a direct current source 26, a current measuring unit 28 being situated in the current circuit thus formed. Direct current source 26 and current measuring unit 28, in turn, are connected to a control unit not shown here in greater detail, using which, an evaluation is made of the acquired measuring signals.

Device 10 shown in FIGS. 1 to 3 works in a manner described below.

For the determination of the boiling point of the brake fluid of the hydraulic circuit, which is conveyed into cavity 14 especially via inlet 16, current is allowed to flow through heating element 24, so that it heats up, and it does that up to the onset of boiling of the brake fluid contained in cavity 14. When the brake fluid boils, little vapor bubbles are created above heating element 24, which are identified in FIG. 2 by reference numeral 30.

The little vapor bubbles 30 have the effect that the heat removal from heating element 24 decreases, whereby the temperature at heating element 24 rises abruptly. From knowing the voltage present at heating element 24 and the current measured with the aid of measuring instrument 28, one may infer the instantaneous electrical resistance of heating element 24. From the known temperature/resistance characteristics curve of heating element 24, which is stored in the control unit, one may infer the temperature prevailing upon the onset of boiling, and consequently the boiling point of the brake fluid.

Because of the creation of the little vapor bubbles 30, brake fluid is displaced from cavity 14 via inlet 16 and outlet 18, based on the shape of inlet 16 and that of outlet 18, but essentially via outlet 18, which is shown in FIG. 2, in the light of arrows X1 and X2 having different thicknesses.

As soon as the boiling of the brake fluid has set in, which is detected in the light of the sudden change in resistance, the heating performance of heating element 24 is reduced, whereby the little vapor bubbles 30 collapse. Because of that, a considerable quantity of brake fluid is sucked into cavity 14 via inlet 16, but brake fluid is also sucked in via outlet 18. This is shown in FIG. 3, in the light of arrows Y1 and Y2 of different thicknesses.

The determination of the boiling point of the brake fluid, in the manner described, is repeated at regular intervals.

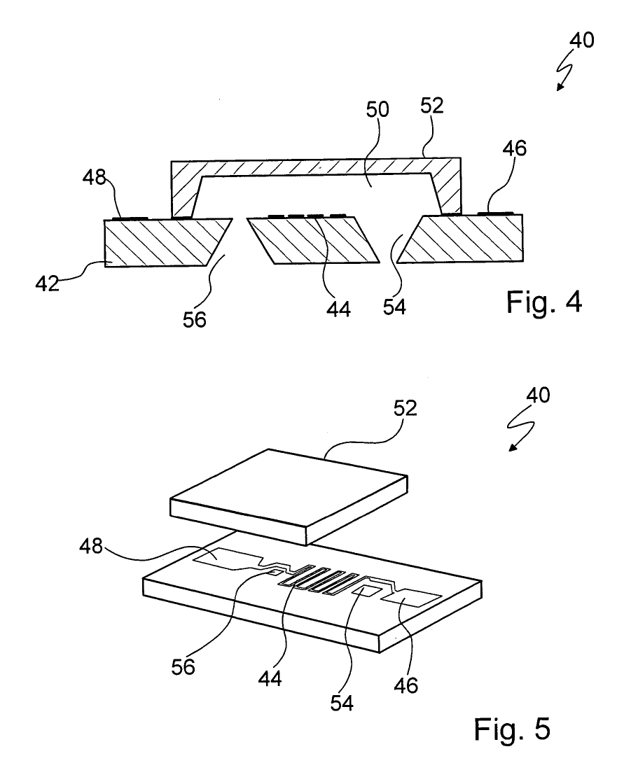

In FIGS. 4 and 5 a concrete specific embodiment is shown, of a device 40 according to the present invention, for use in a braking system of a motor vehicle.

Device 40 includes a substrate 42 made of a silicon monocrystal, onto which a heating element 44 is impressed according to a thin film technique, as well as its connecting contacts 46 and 48 for connecting to a voltage source not shown in greater detail. Heating element 44 is coated with a dielectric made of silicon dioxide.

In order to form a chamber or a cavity 50, substrate 42 is provided with a cap or a cover 52 in the vicinity of heating element 44. Cap 52 is made of heat-resistant glass.

In order to connect cavity 50 to the braking circuit of the braking system, an inlet opening 54 and an outlet opening 56 are etched in. The axis of the two openings 54 and 56 is aligned at right angles to the plane of substrate 42. Via the two openings 54 and 56, brake fluid may be pumped, in the manner described in connection with the device according to FIGS. 1 to 3, through cavity 50, and by doing that the boiling point of the brake fluid may be determined.

The geometric layout of inlet 54, outlet 56, cavity 50 and heating element 44, as well as the operating manner of heating element 44 are selected in such a way that, in the heating process shown in the light of FIG. 2, no little vapor bubbles exit from cavity 50.

Device 40 has a length of about 4 to 6 mm, and a width of about 2 to 4 mm. The diameter of cavity 50 amounts to about 2 to 4 mm. The nozzles or rather inlet 54 and outlet 56 each have a diameter which measures about 20 to 30 μm.

Device 40 is produced according to a silicon micromechanical method, and is therefore suitable especially to be made in large numbers of pieces.

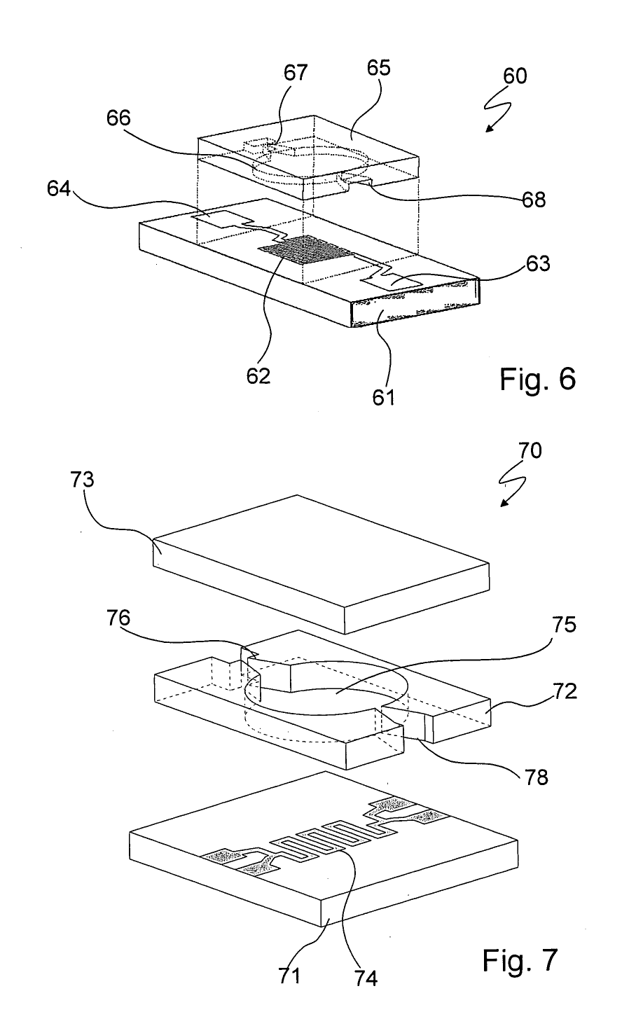

FIG. 6 shows another preferred specific embodiment of a device 60 according to the present invention. Device 60 includes a substrate 61 that is made of glass and is coated with a thin film heating element 62. Thin film heating element 62, in turn, is provided with two electrical terminals 63 and 64, which are also applied onto substrate 61 according to a thin film technique.

In the vicinity of heating element 62 a cover 65 is situated on substrate 61, into which a cavity or rather a chamber 66, as well as an inlet 67 and an outlet 68, are etched. Inlet 67 and outlet 68 each have a trapezoidal layout, the sidewalls in each case being placed at an angle of 4 to 5 degrees to the longitudinal axis of device 60. Cover 65 is made of glass.

FIG. 7 shows another specific embodiment of a device 70 according to the present invention. Device 70 is made of three ceramic layers 71, 72 and 73, which are situated over one another, layer by layer.

Ceramic layer 71 forms a substrate of the device, on which a heating element 74 is positioned, which is laid out to have a four-point tap for measuring temperature. Above substrate 71, there is a cover made up of layers 72 and 73, layer 72 forming an intermediate layer in which a chamber or a cavity 75 as well as an inlet 76 and an outlet 78 are stamped out. The geometry of inlet 76 and outlet 78 corresponds to those of the inlets and the outlets of the device according to FIG. 6.

On intermediate layer 72 ceramic layer 73 is positioned, in turn, as a closing cover element, which also borders cavity 75 as well as inlet 76 and outlet 78.

Device 70, produced according to a ceramic multilayer technique according to the present invention, is advantageously implemented especially in smaller production numbers. Furthermore, this specific embodiment made of ceramic is very stable to temperature and hydraulic fluid.

Moreover, the device according to the present invention is not limited to three ceramic layers, but rather it may include only two, or even more than three layers.

In a specific embodiment, not shown here in greater detail, that is made of plastic, the construction may be implemented of two extrusion-coated, temperature resistant and hydraulic fluid resistant plastic parts. The device may also be produced according to a plastic MID technology, which again proves to be advantageous in the case of small production numbers.

What is claimed is:

1. A device for determining a boiling point of a hydraulic fluid of a hydraulic system, comprising:
an electrical heating element situated in the fluid, the electrical heating element acting as an actuator of a micropump and being situated in a chamber thereof.

2. The device according to claim 1, wherein the device is for determining a boiling point of a brake fluid of a braking system in a motor vehicle.

3. The device according to claim 1, wherein, according to a thin film technique, the heating element is applied to a substrate which is provided with a cover to form a chamber.

4. The device according to claim 3, wherein the chamber has an inlet and an outlet which are situated in one of the substrate and the cover.

5. The device according to claim 3, wherein the substrate is composed of at least one of a semiconductor, heat-resistant glass, a ceramic and plastic, and the cover is composed of at least one of a semiconductor, heat-resistant glass, a ceramic and plastic.

6. The device according to claim 5, wherein the substrate is composed of silicon.

7. The device according to claim 5, wherein the cover is composed of silicon.

8. The device according to claim 1, wherein the heating element is produced from one of aluminum and platinum, and is coated by a dielectric.

9. The device according to claim 1, further comprising a PTC resistor element situated in the chamber.

10. The device according to claim 1, wherein the device has a multilayer construction.

11. A method for determining a boiling point of a fluid of a hydraulic system using a device having a heating element, the method comprising:
conveying the fluid into a chamber of a micropump with the aid of the heating element;
heating the fluid to boiling using the heating element; and
thereafter ascertaining the boiling point of the fluid with the aid of an electrical resistance of the heating element.

12. The method according to claim 11, wherein after an abrupt change in the electrical resistance of the heating element, a heating performance of the heating element is lowered.

13. The method according to claim 11, further comprising operating the heating element in a pulsed manner at regular intervals.
